(19) United States
(12) Patent Application Publication
(10) Pub. No.: US 2023/0108916 A1
(43) Pub. Date: Apr. 6, 2023

(54) METHOD AND SYSTEM FOR FORECASTING NON-STATIONARY TIME-SERIES

(71) Applicants: INDIAN INSTITUTE OF TECHNOLOGY BOMBAY, Powai (IN); SigmaStream LLC, Conroe, TX (US)

(72) Inventors: Vivek S. Borkar, Dadar (West) (IN); Nikhil Karamchandani, Powai (IN); Arbaz Rajvalli Shaikh, Powai (IN); Ravikumar Karumanchi, Bangalore (IN); Hari Koduru, The Woodlands, TX (US)

(21) Appl. No.: 17/937,860

(22) Filed: Oct. 4, 2022

(30) Foreign Application Priority Data
Oct. 5, 2021 (IN) 202121045286

(51) Int. Cl. G06Q 30/0202

(52) U.S. Cl. CPC G06Q 30/0202

(57) ABSTRACT

A method (S1500) and a system (1600) for forecasting in a non-stationary time-series are disclosed. It addresses forecasting in a complex form of non-stationarity in time-series by employing regime-switches. The scope of application of the present invention is wider than that of existing models since it makes automating the process of forecasting easy and practical which in turn aids in generating forecasts at higher frequency than the existing models. It relies on a blend of wavelet transforms and deep learning towards automatic identification of different types of regimes that exist in non-stationary time-series. To overcome the limitations of existing models, it proposes a two-step framework for non-stationary time-series forecasting, where, it employs wavelet theory approach for capturing both high and low frequency components present in the time-series process during different time intervals; and then employs various deep learning models and machine learning algorithms to automatically identify the regime structure present in the time-series.

### TECHNICAL FIELD

The present subject matter described herein, in general, relates to applying signal processing and pre-trained deep learning model to extract features for a forecasting application, and more particularly, it relates to a method and a system for forecasting non-stationary time-series.

### BACKGROUND

Many economic and financial time-series such as asset prices, interest rates, exchange rates, many operational time-series like product component inventories, or sales time-series of fashion items which show occasional spurts are non-stationary in nature. Classical forecasting models like ARMA (Autoregressive Moving Average), and ARIMA (Autoregressive Integrated Moving Average) assume the dynamics to be stationary and linear. More advanced models like ARCH (Autoregressive Conditional Heteroskedastic), GARCH (Generalized Autoregressive Conditional Heteroskedastic) and their variants model time-varying conditional variance of a non-stationary time-series data but cannot fully capture highly irregular phenomena generally observed in many practical time-series. Models from econometrics like Regime Shift non-stationary series build forecasts by segregating the series into different “regimes” or “states” and apply regime-specific forecasting models. However, these regime-shift models are generally hand-crafted, can work when the number of regimes is known a priori and are not fast and flexible enough to accommodate any newly observed regimes.

On the other hand, various machine learning techniques such as Artificial Neural Networks (ANN) and Support Vector Regression (SVR) try to capture and model non-stationary and non-linear time-series data but often suffer from the problem of overfitting, which makes it hard to discern if the model is capturing noise or some probabilistic properties of the time-series.

For some state-of-the-art technology, reference is made to CN 109767043 A which discloses a power load time-series big data intelligent modelling and prediction method. Electric load time-series big data intelligent modelling and prediction techniques, wavelet decomposition is carried out to electric load time-series historical data, electric load time-series historical data is decomposed into electric load high-frequency time-series historical data and frequency temporal sequence history data, then integrated approach is carried out to all time-series, time-series is clustered, the time-series for clustering classification to every kind is based on Elman neural network load forecasting model, finally the electric load after the decomposition of prediction is reconstructed, complete the intelligent modelling to electric load time-series, to realize that the electric load to different characteristic carries out efficiently, intelligent predicting.

Reference is also made to CN 109711383 A which discloses a convolutional neural network motor imagery electroencephalogram recognition method based on a time-frequency domain. The method comprises the steps: original right-hand man's Mental imagery EEG signals are converted to two-dimensional time-frequency figure using Short Time Fourier Transform by S1; S2 takes one-dimensional convolution mode and carries out feature extraction to a kind of 5 layers of convolutional neural networks structure of obtained two-dimensional time-frequency G-Design in order to avoid mixing for Time And Frequency information; S3 utilizes the entire CNN network of back-propagation algorithm training; Support vector machines is replaced the output layer in CNN using support vector machines as the classifier of entire model by S4. The present invention can guarantee to concentrate in EEG data, right-hand man's Mental imagery EEG signals feature discrimination with higher of extraction, and robustness is good.

Reference is also made to CN 108846261 A which discloses a gene expression time-series data classification method based on visibility graph algorithm. The method comprises the steps of: 1) constructing a basic network, selecting data strips according to the pre-processed gene expression time sequence data, constructing a visual image and a connection image through a visual image algorithm, and determining the basic structure of the co-expression network; 2) extracting relevant traditional characteristics according to the obtained basic network; 3) obtaining the characteristic vector of each gene node in the basic network by utilizing second-order random walk and neural network model learning; 4) and integrating the characteristics of the basic network, and finishing the classification of the gene expression time sequence data by using different strategies based on the obtained characteristics of the basic network through a density clustering algorithm. The invention provides a method for realizing gene expression time sequence data classification by adopting visual graph basic network construction, node feature vector extraction and density clustering algorithm, which has good precision and practicability.

Reference is also made to CN 110553839 A which discloses a gear box single and composite fault diagnosis method, equipment and system, and belongs to the field of mechanical equipment state monitoring and fault diagnosis. The diagnostic method comprises the following steps: (1) acquiring a vibration signal of the gear box; (2) dividing the acquired vibration signal into a plurality of data segments, wherein two adjacent data segments have coincident data, and calculating to obtain a wavelet time-frequency image corresponding to each data segment; (3) dividing the wavelet time-frequency image into a training set and a test set, and normalizing; (4) training a multi-label convolutional neural network by using a training set; (5) testing the trained multi-label convolutional neural network by using the test set; (6) and testing the qualified multi-label convolutional neural network as a fault diagnosis model. The method fully utilizes the excellent feature extraction capability of wavelet transformation, the excellent pattern recognition capability of the multi-label convolutional neural network and the applicability to the composite fault diagnosis problem, and can effectively realize the single and composite fault diagnosis of the gearbox.

Reference is also made to CN 109034277 A which discloses a power quality disturbance classification method and system based on multi-feature fusion. The invention describes a methodology that extracts the time-frequency characteristics, fundamental frequency signal, and signal noise intensity to classify Power Quality Disturbance. The method carries out S-transformation, Fourier transformation, and noise intensity measurement on a normalized sampled signal respectively to obtain time-frequency matrix, fundamental frequency signal and signal noise intensity. Through an integrated analysis of the time-frequency image and the matrix, and the fundamental frequency signal, three critical features are obtained. If the signal to noise ratio exceeds a threshold, a decision tree is applied to the identified three features to generate quality disturbance classification; else a probabilistic neural network is applied for classification.

Reference is also made to CN 106909784 A which discloses a recognition method of epileptic electroencephalograph based on two-dimensional time-frequency image depth convolution. The method comprising the steps of: (a) pre-process raw electroencephalograph signals; (b) extract effective frequency bands of the electroencephalograph signals; (c) build time-frequency diagram of the electroencephalograph signals; (d) train a deep convolution neural network LeNet-5 structure on time-frequency diagrams; (e) extract features of images and carrying out data dimensionality reduction through a fully connected network; (f) finally outputting two-dimensional vectors used to represent classification results; (g) selective optimal channels which are specific to a patient and obtain classification results; (h) utilize a weighted sum method on the outputs of the five optimal channels to identify epilepsy.

Reference is also made to CN 108510113 A which discloses an application of XGBoost to short-term load prediction. The invention designs an information entropy clustering and ATTENTION mechanism-based recurrent neural network short-term load prediction method. The method comprises the steps of: a) analyze features influencing a power load; b) calculate information entropies of all the features for the load by using an xgboost algorithm; c) performing cluster analysis based on the feature information entropies as weights for historical data of a prediction area; d) select a cluster with a shortest prediction day weight distance in the clustering result; e) consider prediction time from long to short and form a time sequence T; f) take the time sequence T as an encoder of an ATTENTION recurrent neural network; g) obtain the prediction result using a decoder.

Reference is made to non-patent literature by S Jayalakshmi and G. N. Sudha, titled Scalogram-based prediction model for respiratory disorders using optimized convolution neural networks, Artificial Intelligence in Medicine, 103, 2020 The paper splits respiratory sound signals using Empirical Mode Decomposition and creates scalograms of each intrinsic mode functions thus generated using a continuous wavelet transform. The scalograms are fed into a pretrained optimized Alexnet Convolutional Neural Network (CNN) architecture to predict to four classes of lung sounds-normal, crackles, wheezes and low-pitched wheezes.

Reference is made to non-patent literature by Y Lukic, C Vogt, O. Durr, and T Stadelmann, titled Speaker identification and clustering using convolution neural networks, IEEE International Workshop on Machine Learning for Signal Processing, Salerno, Italy, 2016. The paper uses spectrograms of speech signals as input to a CNN and study the optimal design of CNN networks for speaker identification and clustering. The work determines optimal convolutional filter dimension for effective speaker identification using different training experiments and then uses one of the post-convolutional layers as feature representation needed for clustering. The work demonstrates that using the output of the high level dense layers instead of the final soft-max layer offers improved clustering performance.

Reference is made to non-patent literature by D Verstracte et al, titled Deep learning enabled fault diagnosis using time-frequency image analysis of rolling element bearing, Shock and Vibration, 2017. This paper designs a custom CNN architecture to detect Normal, Inner race fault, Outer race fault condition in rolling element bearings in electric motors and evaluate the architecture against other architectures and machine learning models and establish the architecture robustness under different time frequency methods, Short-term Fourier Transform, Wavelet Transform, and Hilbert-Huang Transform.

Reference is made to non-patent literature by H Abbasi, A Gunn, L Bennet, and C P Unsworth, titled Deep convolutional neural networks and reverse biorthogonal wavelet scalograms for automatic identification of high-frequency micro-scale spike transients in Post-Hypoxic-Ischemic EEG, Conference of the IEEE Engineering in Medicine and Biology Society (EMBC′20), Montreal, Canada, Jul. 2020. This paper employs reverse biorthogonal wavelet-scalograms of ECoG segments to train a 17-layer deep CNN classifier for the precise identification of high-frequency micro-scale spike transient in post-H1 recordings of preterm fetal sheep.

Reference is made to non-patent literature by Y Zhanga, L Leib, Y Weic, titled Forecasting the Chinese stock market volatility with international market volatilities: The role of regime switching, North American Journal of Economics and Finance, 52, 2020. This paper investigates the role of Markov regime switching applied to the base heterogeneous autoregressive model for realized variance (HAR-RV) in the prediction of the Chinese stock market volatility with relevant indices from international markets incorporated. Regime switching model is empirically demonstrated to outperform the model with time varying parameters in predicting the volatility.

Reference is made to non-patent literature by J L Kirkby, D Nguyen, titled Efficient Asian option pricing under regime switching jump diffusions and stochastic volatility models, North American Journal of Economics and Finance, 52, 2020. The work reduces the problem of pricing Asian options in stochastic volatility models to that of a regime switching jump diffusion model and demonstrate its stability and robustness through numerical experiments.

The drawbacks associated with these conventional/known techniques is that the classical models currently employed tend to fit a single model to cover the entire time-series, thereby implying that they are only capable of handling a known regularity that appears throughout the series—like seasonal, cyclical behaviours. Thus, there is a need to identify regimes that are not known a priori.

The above-described need for forecasting non-stationary time-series is merely intended to provide an overview of some of the shortcomings of conventional systems/mechanism/techniques, and is not intended to be exhaustive. Other problems/shortcomings with conventional systems/mechanism/techniques and corresponding benefits of the various non-limiting embodiments described herein may become further apparent upon review of the following description.

### SUMMARY

This summary is provided to introduce concepts related to a method and a system for forecasting non-stationary time-series, and the same are further described below in the detailed description. This summary is not intended to identify essential features of the claimed subject matter, nor is it intended for use in determining or limiting the scope of the claimed subject matter.

The objective of the present invention is to provide a hierarchical scheme for forecasting non-stationary time-series based on machine learning methodologies and classical time-series analysis.

In particular, the present invention discloses a method and a system for a two-stage scheme for forecasting in nonstationary time-series that combines diverse methodologies in order to overcome the drawbacks associated with the prior art.

According to first aspect of the invention, there is provided a method for forecasting in a non-stationary time-series. The method comprising: generating a plurality of time-frequency images for a plurality of overlapping time-series segments of a user-specified window size, wherein the time-frequency images are generated by employing a continuous wavelet and obtaining the continuous wavelet transform at different scales; applying a pre-trained deep convolutional neural network trained on a plurality of images to the time-frequency images to output a high dimensional numerical vector for each time-frequency image; obtaining a 2D representation for each output numerical vector by applying the Uniform Manifold Approximation and Projection (UMAP) on the collection of numerical vectors; partitioning automatically the 2D representations into clusters by applying a clustering algorithm and an objective criterion such as Bayesian Information Criterion (BIC) to select the optimal number of clusters; mapping each sample of the time-series to the cluster corresponding to the time-frequency image of the time-series segment that the sample belongs to, for collecting time-series segments from stretches identified within the time-series samples; assembling a cluster-specific Auto-Regressive Moving Average (ARMA) forecast model considering all the segments of the time-series that belong to the cluster; and maintaining all cluster specific ARMA models in a repository.

According to second aspect of the invention, there is provided a system for forecasting in a non-stationary time-series. The system comprising: a generating unit, an applying unit, an obtaining unit, a partitioning unit, a mapping unit, an assembling unit and a maintaining unit. The generating unit is configured for generating a plurality of time-frequency images for a plurality of overlapping time-series segments of a user-specified window size, wherein the time-frequency images are generated by employing a continuous wavelet and obtaining the continuous wavelet transform at different scales. The applying unit is configured for applying a pre-trained deep convolutional neural network trained on a plurality of images to the time-frequency images to output a high dimensional numerical vector for each time-frequency image. The obtaining unit is configured for obtaining 2D representation for each output numerical vector by applying the Uniform Manifold Approximation and Projection (UMAP) on the collection of numerical vectors. The partitioning unit is configured for automatically partitioning the 2D representations into clusters by applying a clustering algorithm and an objective criterion such as Bayesian Information Criterion (BIC) to select the optimal number of clusters. The mapping unit (1610) for mapping each sample of the time-series to the cluster corresponding to the time-frequency image of the time-series segment that the sample belongs to, for collecting time-series segments from stretches identified within the time-series samples. The assembling unit is configured for assembling a cluster-specific Auto-Regressive Moving Average (ARMA) forecast model considering all the segments of the time-series that belong to the cluster. The maintaining unit is configured for maintaining all cluster specific ARMA models in a repository.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE ACCOMPANYING DRAWINGS

The detailed description is provided with reference to the accompanying figures. In the figures, the digit(s) of a reference number identifies the figure in which the reference number first appears. The same numbers are used throughout the drawings to refer to similar features and components.

FIG. 1 illustrates a block-diagram for the implementation process flow of the forecasting methodology, in accordance with an embodiment of the present invention.

FIG. 2 illustrates a block-diagram of the complete forecasting methodology, in accordance with an embodiment of the present invention.

FIG. 3 illustrates a flow-chart for initialization of the process flow and indicates various input parameters to be provided for its execution, in accordance with another embodiment of the present invention.

FIG. 4 illustrates a flow-chart of time-series segmentation, in accordance with another embodiment of the present invention.

FIG. 5 illustrates a flow-chart for building scalogram images from the time-series, in accordance with another embodiment of the present invention.

FIG. 6 illustrates a flow-chart for a deep convolutional neural network-based feature extraction from time-frequency images, in accordance with another embodiment of the present invention.

FIG. 7 illustrates a flow-chart for clustering and regime mapping on embeddings, in accordance with another embodiment of the present invention.

FIG. 8 illustrates a flow-chart for forecasting model data preparation, in accordance with another embodiment of the present invention.

FIG. 9 illustrates a flow-chart for forecasting model estimation, in accordance with another embodiment of the present invention.

FIG. 10 illustrates a flow-chart for forecasting and evaluation, in accordance with another embodiment of the present invention.

FIG. 11 illustrates a sample time-frequency diagram, called scalogram, of absolute values of the coefficients of the continuous wavelet transform (using the Morlet wavelet) applied to a segment of stock index time-series data in accordance with an embodiment of the present invention.

FIG. 12 illustrates the scatter plot of 2-dimensional feature embeddings generated by the UMAP (Uniform Manifold Approximation and Projection) algorithm, and the clusters obtained from the k-means algorithm, in accordance with the present invention.

FIG. 13 illustrates regimes mapped onto the original time-series, in accordance to the present invention.

FIG. 14 illustrates a comparison of regime-based model vs classical ARMA model, in accordance to the present invention.

FIG. 15 illustrates a complete flowchart of the method for forecasting in a non-stationary time-series.

FIG. 16 illustrates the overall system for forecasting in a non-stationary time-series.

It is to be understood that the attached drawings are for purposes of illustrating the concepts of the invention and may not be to scale.

### DETAILED DESCRIPTION OF THE PRESENT INVENTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

The present invention can be implemented in numerous ways, as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information in a non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

A method and a system for forecasting non-stationary time-series are disclosed. While aspects are described for forecasting in non-stationary time-series, the present invention may be implemented in any number of different computing systems, environments, and/or configurations, the embodiments are described in the context of the following exemplary systems, devices/nodes/apparatus, and methods.

Henceforth, embodiments of the present disclosure are explained with the help of exemplary diagrams and one or more examples. However, such exemplary diagrams and examples are provided for the illustration purpose for better understanding of the present disclosure and should not be construed as limitation on scope of the present disclosure.

The patent CN109767043A performs wavelets-based time-frequency decomposition of power load series to identify low frequency and high frequency segments in the series. Non-overlapping segments at each frequency level are grouped into clusters and group-specific neural networks are developed for forecasting. Predictions from neural networks corresponding to different clusters at each frequency levels are combined together to make the final forecast. The overall procedure involves multiple decomposition and super-positions and is expected to work only on a sufficiently long time series. Further, it is to be ensured that each cluster has a sufficient number of segments for its associated neural network to yield accurate forecasts. The present invention, in contrast builds on time-frequency images instead of numerical coefficients and exploits sophisticated pre-trained deep network architectures developed for images to extract features in order to group the segments into clusters or regimes. Further, the regime-specific forecasting models of the present invention are built on linear models that are easy to explain to the user, in contrast, to a black-box approach based on neural networks. The patent CN106909784 relies on the design of hand-crafted features on power load time-series and on a non-explicable encoder-decoder mechanism to generate forecasts.

The scope of the patent documents and the non-patent literature described in the background portion, are confined to classification-type of problems where each time-segment is bucketed into one of a known number of classes or categories. In the present invention, the number of regimes (which can be viewed as equivalent to classes/categories mentioned in these descriptions) is not known in advance; rather are automatically detected. Moreover, the scope of these existing patent/non-patent literature does not cover forecasting which involves predicting the future behaviour of a time-series. The non-patent literatures describe the classical regime-switching models for forecasting and assume that the underlying time-series has a known number of regimes.

The present invention is primarily intended to address forecasting in a complex form of non-stationarity in time-series that is characterized by regime-switches. However, the methodology and the steps involved herein are applicable to even other milder forms of non-stationarity generally tackled by popular, advanced models like ARIMA, ARCH, GARCH etc. Thus, unlike other existing models which can only forecast the time-series of the type that they are originally designed for, the present invention can be applied to a larger variety of time-series that occur in practice. Further, the model can automatically identify and adapt to any new structural changes that may emerge in the time-series as the series evolves. Hence the invention can help automate the overall process of forecasting and generate reliable forecasts at a higher frequency than is possible through the current models and software.

Some of the problems associated with the conventional techniques are:
A vast majority of the classical models used in practice tend to fit a single model to cover the entire time-series; so are only capable of handling known regularity that appears throughout the series—like seasonal, cyclical behaviours. The approach disclosed herein is generic and is capable of identifying regimes which are not known a priori. The present invention relies on a blend of wavelet transforms and deep learning towards automatic identification of different types of regimes that may exist in a non-stationary time-series.
To identify a right model for forecasting using the traditional forecasting approaches, numerous transformations must be applied to a non-stationary series and a multitude of parameters must be estimated. Any automated, programmatic approach that uses a grid search over all possible values of the parameters at each stage of model building is often very time consuming and cannot scale to large time-series, particularly when the series exhibits long term dependencies such as business cycles. Further, estimation of a best model is often elusive because of limited availability of time-series data.
The conventional regime switching forecasting models can only work on a finite number of known regimes. Such a structure is often restrictive because the dynamics of any practical time-series is often affected by external factors and hence, the number of regimes such a series passes through, is generally not known a priori.
The existing models for forecasting in non-stationary time-series require statistically significant number of observations to detect change in structural behaviour or change in regime. An early detection of such changes will help choose a right model and improve forecast performance. In the methodology of the present invention, the novel wavelet-based time-frequency analysis coupled with automatic regime identification using deep learning model will lead to early detection of regime switches so that an appropriate regime-specific model can be picked up at the time of forecast.
Advanced black-box machine learning models can approximate complex series up to a high degree of accuracy but, unlike the classical models, lack explicability, a critical requirement for practical implementations.
Accordingly, to strike a balance between handling complexity and explicability there is a need for a methodology that fuses machine learning methodologies with classical time-series analysis so that a wide range of time-series patterns that appear in practice can be forecast with a high degree of accuracy. The present invention discloses a two-stage scheme for forecasting in nonstationary time-series that combines diverse methodologies, such as time-frequency plots from signal processing, deep convolutional neural network-based feature extraction, low dimensional embedding for visualization, and clustering algorithms from machine learning, and finally, classical time-series analysis based on linear models for stationary time-series.

The present invention relies on a blend of wavelet transforms and deep learning towards automatic identification of different types of regimes that may exist in a non-stationary time-series. Motivated by the limitations of the existing works, the present invention proposes a two-step framework for non-stationary time-series forecasting, where, in the first step, it uses the wavelet theory approach for capturing both high and low frequency components present in the time-series process during different time intervals. Later, it employs various deep learning models and machine learning algorithms such as RESNET50 (Residual Networks 50), UMAP, and k-means clustering to automatically identify the regime structure present in the time-series. In the second step, it estimates the classical ARMA model in an altered fashion, using all the time-series segments belonging to regime of interest—regime which consists of the most recent time-series segment. In this step, it is by construction of the framework that the same ARMA model will govern the evolution of all the time-series segments in the regime of interest. Accordingly, the scheme to model non-stationary data is different from those of the prior art in a way that it incorporates the regime structure while simultaneously focusing on capturing various localized frequency components present in localized time-series segments. The experiments on a financial time-series data set demonstrate efficacy of the methodology in yielding high forecast accuracy even in the presence of irregular patterns.

Many time-series data, such as stock prices, surface torque in oil-well drilling, sales of fashion items and so on, follow different dynamics in different time periods. A regime implies a characteristic dynamical behaviour of the time-series over a period and a shift suggests an abrupt change from one characteristic behaviour to another. The present invention pertains to forecasting in a complex, more generic form of non-stationary time-series characterized by such regime-switching behaviour. However, the methodology proposed in the present invention is applicable to even simpler stationary time-series.

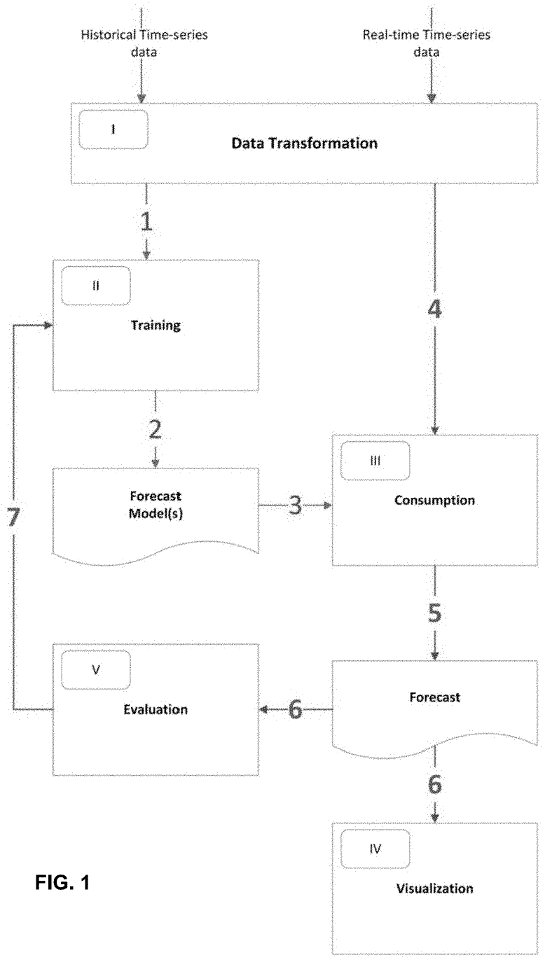

FIG. 1 illustrates the implementation process flow of the invention. It describes how the regime-based forecasting model trained on historical data can be applied to newly arriving data points for real-time consumption by downstream applications.
1. At any given time n, all observations collected in sequence up to time (n−1), referred to as historical time-series hereafter, will be subject to a series of data transformations (in module I of FIG. 1) leading to partitioning of the historical series into clusters of time-segments. Each cluster thus obtained will represent a regime of the time-series. In the particular case of stationary time-series, the number of clusters degenerates to one cluster.
2. The clusters of time-series segments found in Step (1) are then passed on to the training module ((2) in FIG. 1) which will generate cluster-specific forecasting models.
3. The pool of forecasting models of Step (2) is maintained in the usage module to generate single-step/multi-step ahead forecasts at every rolling time-step.
4. Any new real-time observation at time t passes through the regime detection module and gets mapped to an appropriate regime.
5. Upon identification of the regime in Step (4), the corresponding regime-specific forecasting model from the usage module is used to generate forecasts up to t+h for a pre-specified time horizon, h, in future.
6. Forecasting
   i. The forecasts generated in Step (5) can be consumed by any downstream application such as a dashboard for visualization, or any planning system (such as inventory planning systems that use sales forecast time-series, for example).
   ii. The generated forecasts will be evaluated for accuracy (against various accuracy metrics) in the evaluation module (V of FIG. 1) and the actual realized observations are sent to the training module for fine-tuning the model parameters for improved performance.

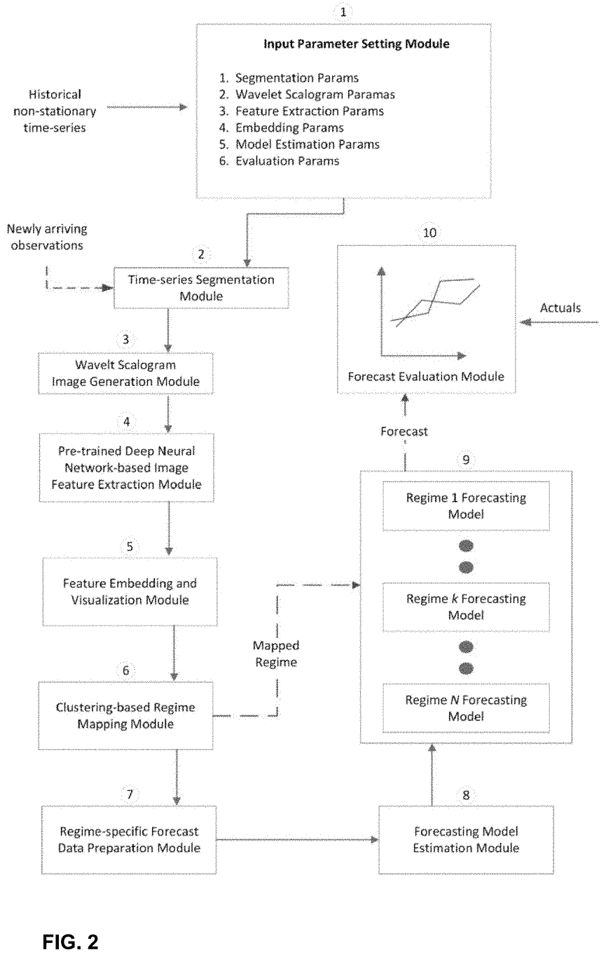

FIG. 2 illustrates how the process flow of FIG. 1 is implemented through a system of interconnected modules and executed according to the sequence depicted in the system diagram of FIG. 2. The various modules of FIG. 2 are described hereinbelow in detail.

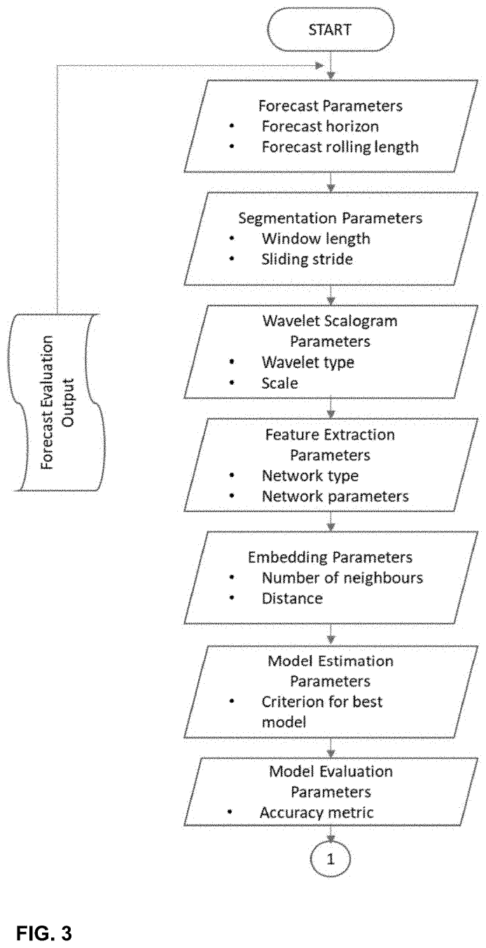

Input Parameter Specification Module: (Module 1): This module collects all the input parameters required for the forecasting methodology of the present invention. Default values used in the current embodiment are shown in parentheses. This module collects user inputs for following parameters required for execution of all the subsequent modules:
i. Forecasting Parameters
   a) Forecast Horizon: h—the length of time into the future for which forecasts are to be made. (Default: h=1)
   b) Select forecast rolling interval: s—the interval between two successive forecasts with add/drop process where previous period forecasts are dropped and replaced with realized actuals while making forecast for the next period. (Default: s=1)
ii. Time-series segmentation parameters:
   a) Window length w—the length of each time segment (Default: w=21)
   b) Stride for sliding window: l (Default: l=1)
iii. Wavelet-based scalogram image parameters
   a) Wavelet type such as Morlet, Mexican hat (Default: Morlet)
   b) Scale—a dyadic scale ranging from 2⁰ to 2¹⁰ (Default: 2⁵)
iv. Feature extraction parameters
   a) Type of pre-trained deep convolutional neural network like ResNet50, LeNet5, VGG16 etc. (Default: ResNet50)
v. Feature embedding parameters for UMAP-based dimensionality reduction
   a) The number of neighbouring points (Default: 30)
   b) Distance (Default: 0.3)
vi. Clustering and regime mapping
   a) The criterion for selection of optimal number of clusters (Default: Bayesian Information Criterion)
vii. Forecasting model estimation parameters
   a) Criterion for selection of the best model (Default: Akaike Information Criterion)
v. Forecast evaluation parameters
   a) Accuracy metrics for model performance evaluation like Mean Absolute Percentage Error (MAPE), Mean Absolute Deviation (MAD) etc. (Default: MAPE)
vi. FIG. 3 gives the flow chart for input parameter specification.

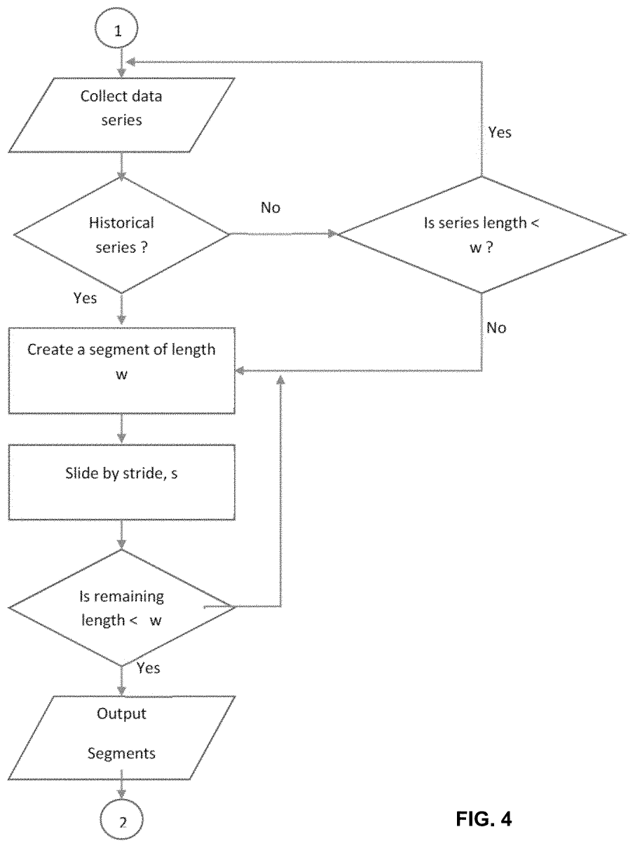

Time-series segmentation module (Module 2): carries out the following steps and outputs a collection of time-series segments.
vii. Find the length n of the historical time-series
viii. Create a collection of overlapping segments of window length w from the time-series: (y₀, . . . , yₙ₋₁) with slide l. Size of the historical time-series segments equals ((n−w)/l+1).
ix. Output all the ((n−w)/l+1) segments generated from (ii)
x. For a newly arriving observation at time n, output its associated time-segment by considering the sub-series (y_{n-w+1}, . . . , yₙ)
xi. FIG. 4 illustrates the flow-chart for time-series segmentation.

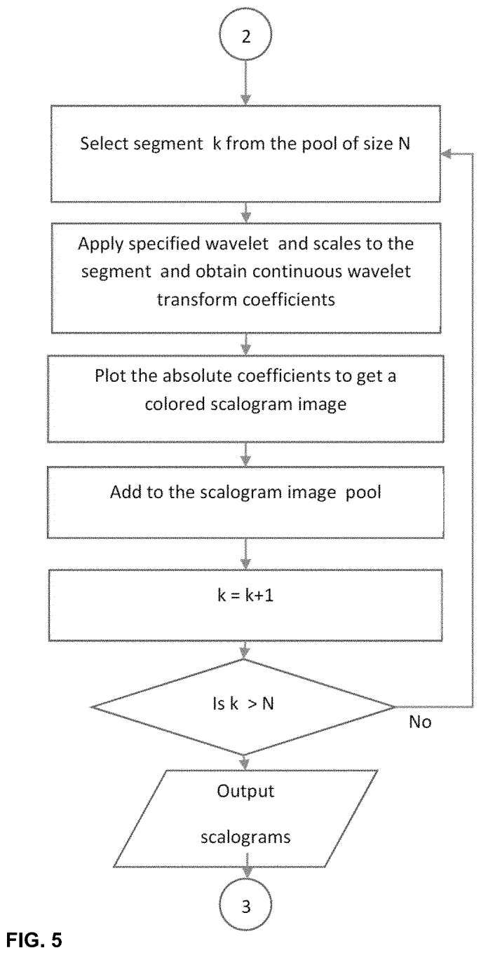

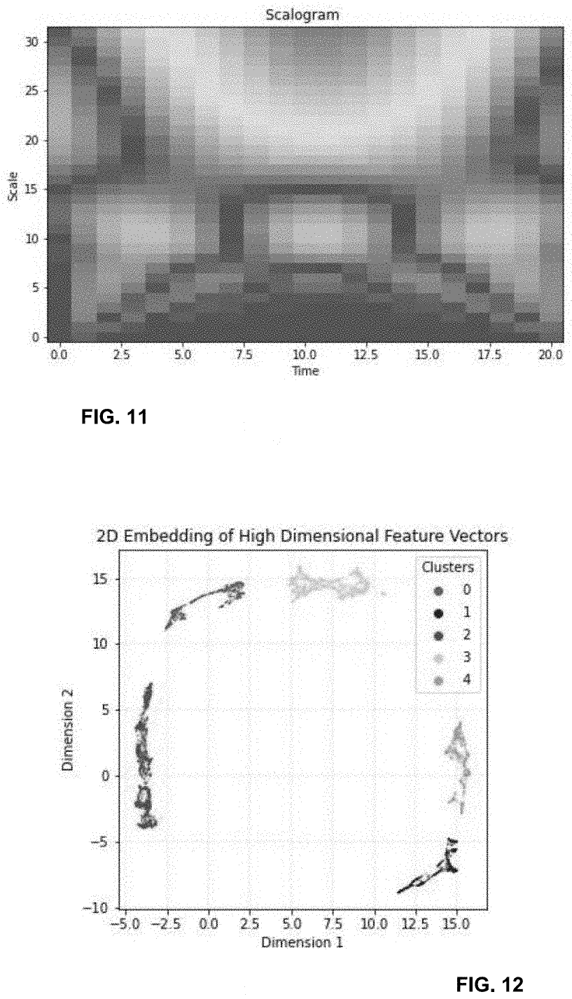

Wavelet Scalogram Module (Module 3) generates scalogram image from a time-series segment.
xii. On each time-series segment belonging to the output of Module-2 compute continuous wavelet transform Wy for different pairs of time and scale, (u, s) and the wavelet type ψ selected in the input parameter setting module given by

$$W y ( u , s ) a = \frac{1}{\sqrt{s}} {\int }_{- ∞}^{∞} y ( t ) {ψ}^{⋆} ( \frac{t - u}{s} ) dt$$

where the mother ψ wavelet is assumed to have zero mean, and s is varied over the scale range selected in the parameter setting module.
xiii. Plot the absolute values of Wy(u, s) for different pairs of (u, s) to generate time-frequency images, called scalograms.
xiv. Output the collection of scalograms generated.
xv. FIG. 5 illustrates the flow-chart for building the scalogram from a time-series segment.
xvi. FIG. 11 shows the scalogram of a sample time-series segment obtained using the Morlet wavelet. With time along the x-axis and scale (which is inversely related to frequency) along the y-axis, the plot shows a tiling of the frequency vs time plane. The color-coded intensity in each tile indicates the strength of correlation between the signal and the wavelet.

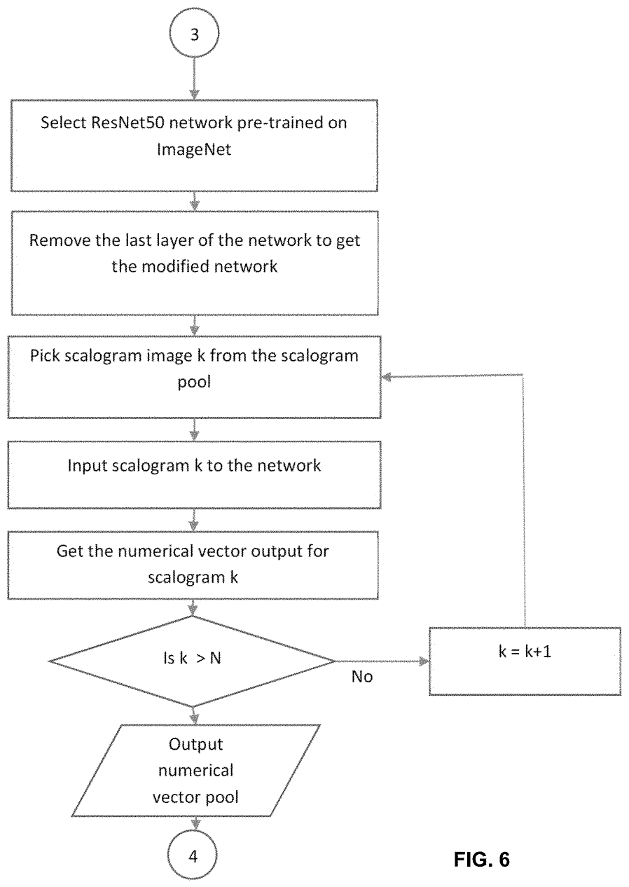

Numerical Vector Extraction Module (Module 4): extracts a numerical vector from each scalogram images using a pre-trained neural network.
xvii. Choose any classification-based deep convolutional neural network pre-trained on image data that will generate a flat feature vector in its penultimate layer. In the current embodiment, the default network is a pre-trained ResNet50 trained on ImageNet data set.
xviii. Retain the weights of pre-trained network selected and remove one or more of the last layers of the network.
xix. Pass each scalogram image from the output of previous module through the network to obtain a feature vector. The default ResNet50 generates a feature vector of size 2048.
xx. Output the collection of feature vectors.
xxi. FIG. 6 illustrates the flow-chart to extract numerical vectors from scalograms using the ResNet50 deep convolutional neural network.

Embedding module (Module 5): Uses UMAP (Uniform Manifold Approximation and Projection) to reduce the dimensionality of a given numerical vector to two dimensions without distorting the global structure of the collection of the numerical vectors.
xxii. Apply UMAP algorithm with the specified parameter settings (the count of neighbours and distance) on the feature vector outputs of previous module to generate a reduced, two-dimensional embedding of the aforementioned numerical vectors.
xxiii. The generated vectors can be visualized in a two-dimensional scatter plot which is faithful to the pairwise proximity or lack thereof of the original high dimensional numerical vectors.
   Output the collection of all two-dimensional embedding vectors generated from the input feature vectors.

Clustering and regime mapping module (Module 6):
xxvii. Pass the collection of two-dimensional embedding vectors through the K-means clustering algorithm to obtain a cluster-based grouping of these feature vectors.
xxviii. The optimal number of clusters k* is determined by following the criterion specified in the parameter setting. In this embodiment, the Bayesian Information Criterion (BIC) procedure is utilized and described below:
   Use the Kass and Wasserman BIC formula:

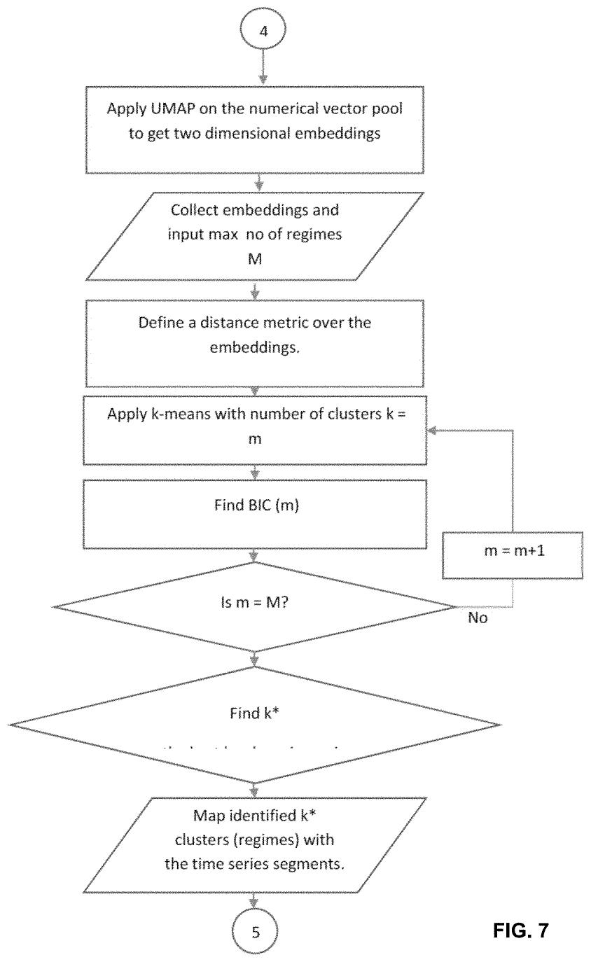

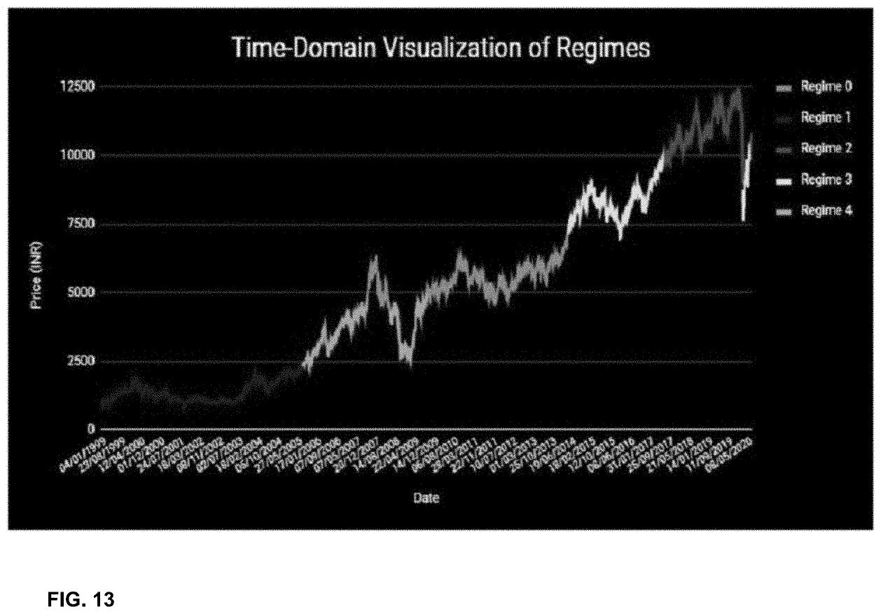

BIC(m)=L(θ)−½m log(n)

where L(θ) is the loglikelihood function according to a selected model, m is the total number of clusters, and n is the data size. Use the following formula for BIC derived under identical spherical Gaussian distribution assumption of points within clusters:

$$BIC ( m ) {\sum }_{i = 1}^{m} ( log {n}_{i} - {n}_{i} log n - \frac{{n}_{i} * d}{2} log ( 2 π ) - \frac{{n}_{i}}{2} log {\sum }_{i} - \frac{{n}_{i} - m}{2} ) - \frac{1}{2} m log n$$

where m is the number of clusters, nᵢ is the number of points in cluster i, and d is the dimension of the data set. Further,

$${\sum }_{i} = \frac{1}{{n}_{i} - m} {\sum }_{j = 1}^{{n}_{i}} {‖ {x}_{j} - {C}_{i} ‖}^{2}$$

where nᵢ is the size of i^{th} cluster, xⱼ is j^{th} point in cluster i, and Cᵢ is the center of the cluster Cᵢ.
xxix. Iteratively compute BIC(m) for different values of m within the specified range and determine a local maximum to find the right number of clusters on the 2-d feature vectors.
xxx. Each point in the 2-dimensional feature vector collection is originally a time-series segment of window length w. Hence clustering over the 2-d points identifies a cluster for each time-segment. Each cluster represents a regime in the present invention.
xxxi. Consider each sample of the original time-series, identify the segment to which belongs to and assign the sample to the same cluster or regime that the segment belong to. This procedure is referred to as regime mapping hereafter. Output the time-series with regimes mapped.
xxxii. FIG. 7 illustrates the flow-chart for embedding, clustering, and regime mapping on the embeddings.
xxxiii. FIG. 12 shows the sample clusters identified by the above algorithm in the case of the financial time-series considered in the present embodiment.
xxxiv. FIG. 13 illustrates the regimes (or clusters) mapped onto the original time-series, in accordance with the present invention. Each point belonging to a cluster/regime shown in FIG. 4 corresponds to the scalogram image of a specific time-series segment, and all points within the specific segment belong to the same cluster/regime. Using this fact, in FIG. 5, every sample of the original time-series is mapped to the cluster it belongs to and is coloured according to the colour of the corresponding cluster in FIG. 4. Thus, each coloured region of the time-series represents a regime. While different regimes exhibit different dynamical behaviours, all non-contiguous portions belonging to a single regime (such as Regime 0, Regime 3, and Regime 4 in the figure) exhibit the same dynamical behaviour.

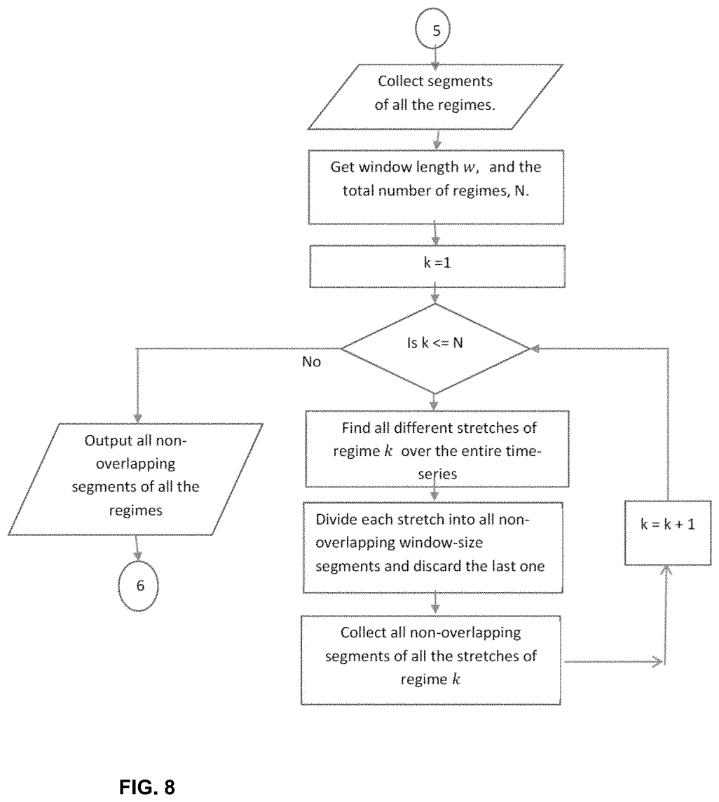

Model data preparation module (Module 7)
xxxv. From the output of Module 6, for each regime, collect all contiguous stretches belonging to each regime. Different stretches of each regime are separated in time
xxxvi. Divide each stretch of a regime into contiguous non-overlapping time-series segments of length w and discard the last segment in the collection. Repeat the procedure to get all non-overlapping segments for each stretch of the regime.
xxxvii. Output all non-overlapping segments of each stretch of each regime.
xxxviii. FIG. 8 illustrates the flow-chart for the above data preparation needed to build the regime-based forecast model.

Model estimation module (Module 8): The following model estimation procedure is described for a regime, say k, and is repeated for each regime to build regime-specific forecasting models:
xxxix. From the output of module 7, collect all the non-overlapping time-series segments belonging to regime k.
xl. Apply kernel regression to each non-overlapping time-series segment obtained in point (xxxvii) above to remove trend within the segment and apply transformations (such as log transformation) if necessary, to convert the segment into a stationary series. The following kernel regression model is used to estimate trend in a segment: Assuming a non-linear trend ƒ of the form:

Yₜ=ƒ(t)+∈ₜ,

approximate ƒ from the T observations (y₀, . . . , yₜ, . . y_{T}) by

$$f ( t ) = \frac{\frac{1}{T h} {Σ}_{i = 1}^{T} {y}_{t} K ( t , i )}{\frac{1}{T h} {Σ}_{i = 1}^{T} K ( t , i )}$$

where K(. , .) is a kernel and h is the bandwidth that determines the smoothing effect. In this embodiment, the Gaussian kernel is used:

$$K ( t , i ) = exp ( - \frac{{( t - i )}^{2}}{{h}^{2}} )$$

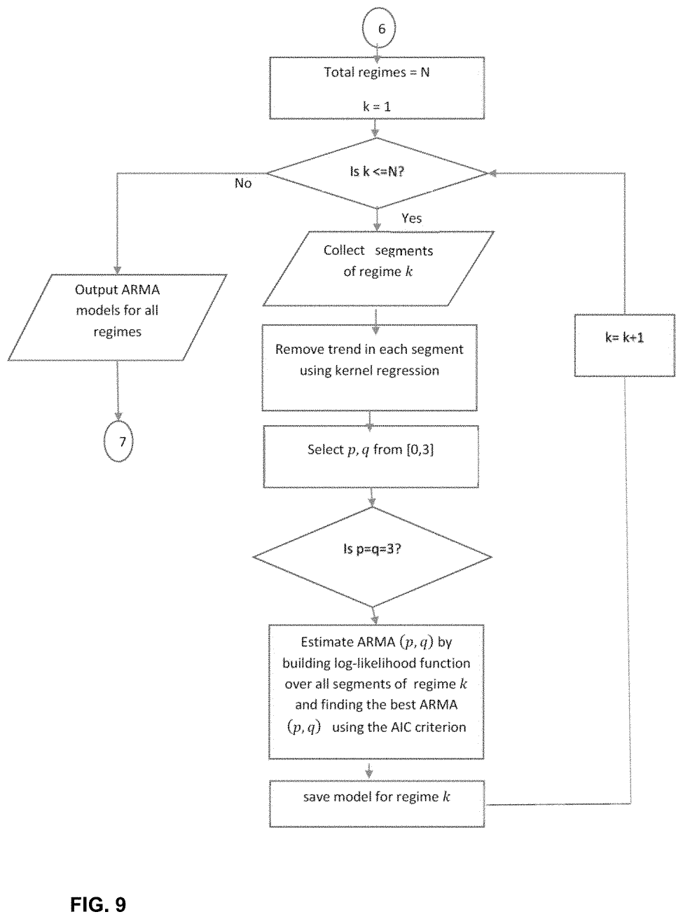

xli. To fit an ARMA(p, q) (Auto-Regressive Moving Average model with p auto-regressive terms and q moving average error terms) model for regime k, log-likelihood function is used to extend to all the non-overlapping time-series segments of regime k
xlii. The best p, q values are obtained by comparing model AIC (Akaike Information Criterion) values for different values of p, q within the range [0,3].
xliii. Find the best ARMA(p, q) model for each regime and output the pool of models.
xliv. FIG. 9 illustrates the flow-chart for forecasting model estimation.

Forecasting module (Module 9):
xlv. Maintain the pool of regime-specific ARMA(p, q) models found in the clustering step of historical time-series data for real-time implementation.
xlvi. For a newly arriving observation at time n, create the window [n−w+1, n] within the time-segmentation module and pass it through the sequence of modules 3 to 6 to identify the regime of the new segment.
xlvii. Use the ARMA(p, q) model corresponding to the regime k identified above to make a forecast for the specified forecast horizon h.

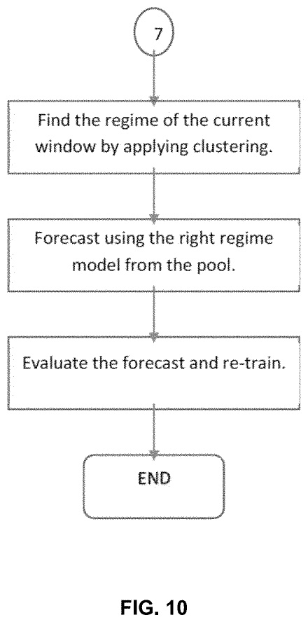

Forecast evaluation module (Module 10) to evaluate accuracy for forecasts against actuals.
xlviii. Collect forecasts from regime-specific models for the specified time horizon.
xlix. Evaluate forecast accuracy with respect to actuals using the metrics specified in the parametric selection module. The default measure of the embodiment is Mean Absolute Percentage Error, given by

$$M A P E ( y , = \frac{1}{N} {\sum }_{i = 1}^{N} \vert \frac{{y}_{i} - \hat{{y}_{l}}}{{y}_{i}} \vert * 100$$

where y and ŷ refer to actuals and forecasts respectively. Evaluated accuracy is used for adjusting the input parameters, if necessary, for improved training and test accuracy.
l. FIG. 10 illustrates the flow-chart for the above forecasting and evaluation.

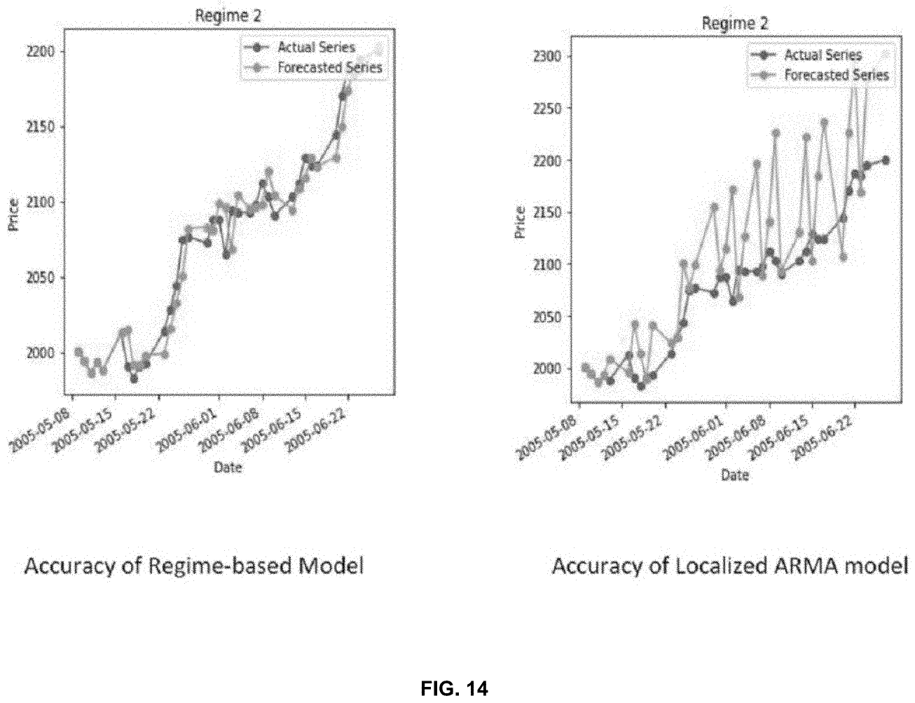

FIG. 14 illustrates the comparison of forecasts based on the regime-based model and the localized ARMA model. In particular, it compares predictive accuracies of the regime-based forecasting model and the localized Autoregressive Moving Average (ARMA) model. The latter is estimated after applying the necessary differencing and transformations needed to convert the series into a stationary series. Forecasts from the regime-based model are observed to be closer to the actuals than the ones obtained from localized ARMA. Thus, the regime-based model of the present invention is able to extract structural similarities present in different windows of the time series and fuse the windows with similar behaviours together to fit a more precise model than the localized ARMA.

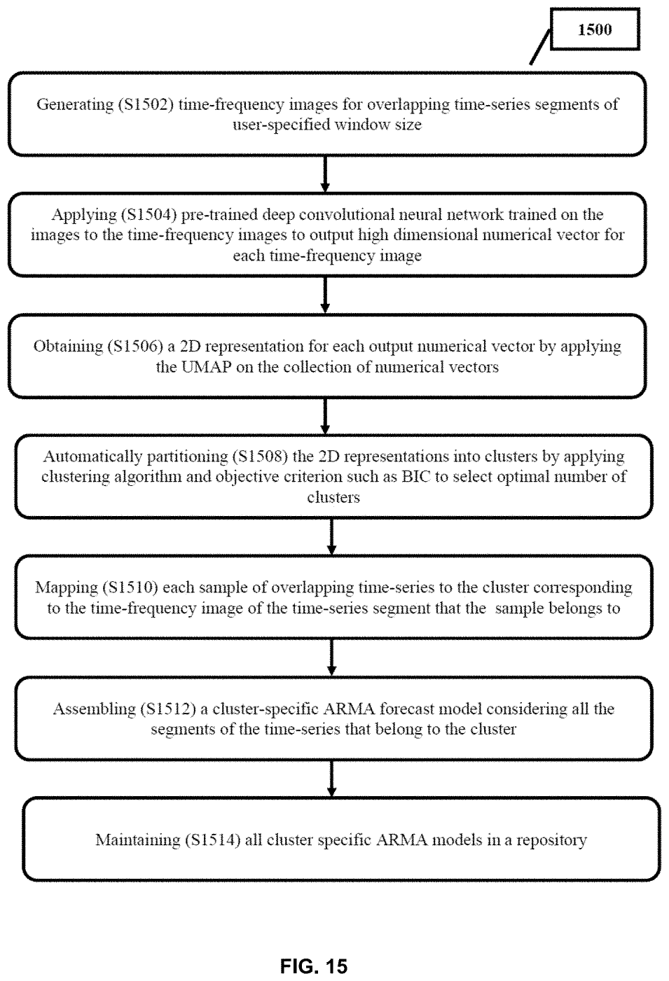

FIG. 15 illustrates a flowchart of the method (S1500) for forecasting in a non-stationary time-series, the method comprising:
generating (S1502) a plurality of time-frequency images for a plurality of overlapping time-series segments of a user-specified window size, wherein the time-frequency images are generated by employing a continuous wavelet and obtaining the continuous wavelet transform at different scales;
applying (S1504) a pre-trained deep convolutional neural network trained on a plurality of images to the time-frequency images to output a high dimensional numerical vector for each time-frequency image;
obtaining (S1506) a 2D representation for each output numerical vector by applying the Uniform Manifold Approximation and Projection (UMAP) on the collection of numerical vectors;
partitioning automatically (S1508) the 2D representations into clusters by applying a clustering algorithm and an objective criterion such as Bayesian Information Criterion to select the optimal number of clusters.
mapping (S1510) each sample of the time-series to the cluster corresponding to the time-frequency image of the time-series segment that the sample belongs to, for collecting time-series segments from stretches identified within the time-series samples;
assembling (S1512) a cluster-specific Auto-Regressive Moving Average (ARMA) forecast model considering all the segments of the time-series that belong to the cluster; and
maintaining (S1514) all cluster specific ARMA models in a repository.

Any continuous wavelet is used to generate time-frequency images for each time-series segment; and wherein the default wavelet is set to Morlet wavelet. The pre-trained deep convolutional neural network is applied to each time-frequency image to output a high dimensional numerical vector; and wherein the neural network is set to ResNet50.

The step of partitioning automatically (1508) the 2D representation points into clusters further comprises: applying the BIC over a plurality of different clusters; and selecting a plurality of clusters that correspond to the maximal BIC.

The step of assembling (S1512) a cluster-specific forecast model further comprises: collecting all the non-overlapping time-series segments belonging to the cluster; removing trend from each window-size segment to convert each window-size segment of the time-series into a stationary time-series segment; and applying an ARMA model over the collection of stationarized segments of each partition, wherein the model is identified by selecting the number of autoregressive terms, p, and the number of moving average terms, q according to the AIC criterion.

The method further comprises: performing (S1516) forecasts on the time-series at any time t for a future horizon, h, at every new instant.

The step of performing forecasts on the time-series at any time t for a future horizon, h further comprises: considering a window length segment of the time-series backwards from t; generating the time-frequency image corresponding to the window length segment of the time-series by applying the continuous wavelet transform using the user-selected wavelet; passing the generated time-frequency image through the deep convolutional neural network to extract a numerical vector from the said time-frequency image; identifying the matching cluster for the time-frequency image by applying the UMAP; selecting the corresponding cluster specific model in the repository using the index of the identified cluster; and forecasting the h future values using the selected cluster-based model.

The method further comprises: performing (S1518) the method (1500) periodically whenever the time-series collects a fixed number of new points; and storing (S1520) the cluster—specific refined models in the repository.

The step for mapping (S1510) each sample of the time-series to the cluster corresponding to the time-frequency image of the time-series segment that the sample belongs to, further comprises the steps of: identifying different contiguous stretches of the time-series within the time-series samples mapped to the same cluster; dividing each stretch into non-overlapping window-size segments; and discarding the last segment of the stretch and collecting the remaining segments from each stretch.

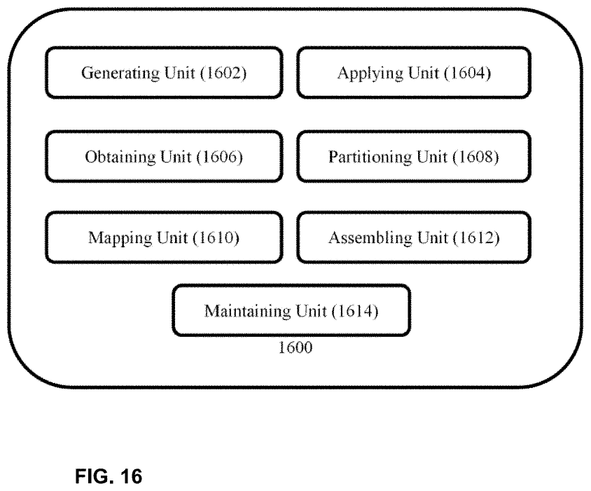

FIG. 16 illustrates a system (1600) for forecasting in a non-stationary time-series. The system comprising: a generating unit (1602), an applying unit (1604), an obtaining unit (1606), a partitioning unit (1608), a mapping unit (1610), an assembling unit (1612) and a maintaining unit (1614). The generating unit (1602) is configured for generating a plurality of time-frequency images for a plurality of overlapping time-series segments of a user-specified window size, wherein the time-frequency images are generated by employing a continuous wavelet and obtaining the continuous wavelet transform at different scales. The applying unit (1604) is configured for applying a pre-trained deep convolutional neural network trained on a plurality of images to the time-frequency images to output a high dimensional numerical vector for each time-frequency image. The obtaining unit (1606) is configured for obtaining 2D representation for each output numerical vector by applying the Uniform Manifold Approximation and Projection (UMAP) on the collection of numerical vectors. The partitioning unit (1608) is configured for automatically partitioning the 2D representations into clusters by applying a clustering algorithm and an objective criterion such as Bayesian Information Criterion (BIC) to select the optimal number of clusters. The mapping unit (1610) is configured for mapping each sample of the original (overlapping) time-series to the cluster corresponding to the time-frequency image of the time-series segment that the sample belongs to and identifying continuous stretches of each regime in the time-series, dividing each stretch into non-overlapping time-series segments of size w; and discarding the last segment and collecting all other segments from each stretch.

The assembling unit (1612) is configured for assembling a cluster-specific Auto-Regressive Moving Average (ARMA) forecast model considering all the non-overlapping segments of the time-series that belong to the cluster. The maintaining unit (1614) is configured for maintaining all cluster specific ARMA models in a repository.

The partitioning unit (1608) for automatically partitioning the 2D representation points into clusters further comprises: an applying unit (16081) for applying the BIC over a plurality of different clusters; and a selecting unit (16082) for selecting a plurality of clusters that correspond to the maximal BIC.

The assembling unit (1612) for assembling a cluster-specific forecast model further comprises: a collecting unit to collect all non-overlapping time-series segments of the cluster; a removing unit (16122) for removing trend from each window-size segment of the time-series into a stationary time-series segment; and an applying unit (16123) for applying an ARMA model over the collection of stationarized partitions of the cluster, wherein the model is identified by selecting the number of autoregressive terms, p, and the number of moving average terms, q using the AIC criterion.

The mapping unit (1610) further comprises: a collecting unit (16101) for identifying different contiguous stretches of the time-series within the time-series samples mapped to a cluster; a dividing unit (16102) for dividing each stretch into contiguous non-overlapping window size segments; and a discarding unit (16103) for discarding the last segment of the stretch and collecting the remaining segments from each stretch.

The system also comprises: a performing unit (1616) for performing forecasts on the time-series at any time t for a future horizon, h, at every new instant.

The performing unit (1616) for performing forecasts on the time-series at any time t for a future horizon, h further comprises: a window length segment unit (16161) for considering a window length segment of the time-series backwards from t; a generating unit (16162) for generating the time-frequency image corresponding to the window length segment of the time-series by applying the continuous wavelet transform using the user-selected wavelet; a passing unit (16163) for passing the generated time-frequency image through the deep convolutional neural network to extract a numerical vector from the said time-frequency image; an identification unit (16164) for identifying the matching cluster for the time-frequency image by applying the UMAP; a selecting unit (16165) for selecting the corresponding cluster specific model in the repository using the index of the identified cluster; and a forecasting unit (16166) for forecasting the h future values using the selected cluster-based model.

The present invention highlights integrating sophisticated techniques from multiple domains—wavelet-based time-frequency analysis from signal processing to automatically visualize local behaviours along time and frequency axes, extracting important features from the time-frequency plots using a pre-trained deep convolutional neural network, applying dimensionality reduction to easily discern clusters or groupings in features, and automating the process of grouping the features, and finally, applying classical time-series forecasting models separately for each group. Unlike other existing techniques, no assumptions are made regarding the nature or structure of the time-series to generate forecasts.

The present invention finds its application in the field of engineering, economics, and finance domains, for example, stock forecasts, sales forecasting of fashion items, surface torque prediction in oil and gas well drilling, power consumption forecasts on grids and the like. The technical impact offered by the present invention is that it allows to make forecasts on a complex non-stationary time-series with high degree of accuracy compared with the classical models. The wavelet-based approach blended with deep learning is capable of detecting potential changes in the structure of the time-series such as changes in the cyclical components and abrupt short-length changes with high fidelity. The machine learning scheme used in the invention uses transfer learning from a pre-trained deep convolutional neural network reducing the need for large data sets to train the models.

Some of the non-limiting advantages of the present invention are indicated herein below:
The methodology of the present invention can be extended to forecasting in vector time-series, that is, the case where multiple time-series dynamically evolve together. The methodology of the current invention can also be adapted for symbolic time series.
The forecast in such series may be probabilistic, i.e., assigning a probability with each possible symbol to follow. Such forecasting models can be highly effective in early detection of anomalies and incipient faults in complex systems with many interconnected components.

Although implementations for the method and a system for forecasting non-stationary time-series has been described in a language specific to structural features and/or methods, it is to be understood that the appended claims are not necessarily limited to the specific features or methods described. Rather, the specific features and methods are disclosed as examples of implementations of a hierarchical scheme for forecasting non-stationary time-series based on machine learning methodologies and classical time-series analysis.

We claim:

1. A method (S1500) for forecasting in a non-stationary time-series, the method comprising:
generating (S1502) a plurality of time-frequency images for a plurality of overlapping time-series segments of a user-specified window size, wherein the time-frequency images are generated by employing a continuous wavelet and obtaining the continuous wavelet transform at different scales;
applying (S1504) a pre-trained deep convolutional neural network trained on a plurality of images to the time-frequency images to output a high dimensional numerical vector for each time-frequency image;
obtaining (S1506) a 2D representation for each output numerical vector by applying the Uniform Manifold Approximation and Projection (UMAP) on the collection of numerical vectors;
partitioning automatically (S1508) the 2D representations into clusters by applying a clustering algorithm and an objective criterion such as Bayesian Information Criterion (BIC) to select the optimal number of clusters;
mapping (S1510) each sample of the time-series to the cluster corresponding to the time-frequency image of the time-series segment that the sample belongs to, for collecting time-series segments from stretches identified within the time-series samples;
assembling (S1512) a cluster-specific Auto-Regressive Moving Average (ARMA) forecast model considering all the non-overlapping segments of the time-series that belong to the cluster; and
maintaining (S1514) all cluster specific ARMA models in a repository.

2. The method as claimed in claim 1, wherein any continuous wavelet is used to generate time-frequency images for each time-series segment; and wherein the default wavelet is set to Morlet wavelet.

3. The method as claimed in claim 1, wherein the pre-trained deep convolutional neural network is applied to each time-frequency image to output a high dimensional numerical vector; and wherein the neural network is set to ResNet50.

4. The method as claimed in claim 1, wherein partitioning automatically (1508) the 2D representation points into clusters further comprises:
applying the BIC over a plurality of different clusters; and
selecting a plurality of clusters that correspond to the maximal BIC.

5. The method as claimed in claim 1, wherein assembling (S1512) a cluster-specific forecast model further comprises:
removing trend from each time-series segment of the collection to convert each window-size segment of the time-series into a stationary time-series segment; and
applying an ARMA model over the collection of stationarized segments of the cluster, wherein the model is identified by selecting the number of autoregressive terms, p, and the number of moving average terms, q according to the Akaike Information Criterion (AIC).

6. The method as claimed in claim 1, further comprising:
performing (S1516) forecasts on the time-series at any time t for a future horizon, h, at every new instant.

7. The method as claimed in claim 6, wherein performing forecasts on the time-series at any time t for a future horizon, h further comprises:
considering a window length segment of the time-series backwards from t;
generating the time-frequency image corresponding to the window length segment of the time-series by applying the continuous wavelet transform using the user-selected wavelet;
passing the generated time-frequency image through the deep convolutional neural network to extract a numerical vector from the said time-frequency image;
identifying the matching cluster for the time-frequency image by applying the UMAP;
selecting the corresponding cluster specific model in the repository using the index of the identified cluster; and
forecasting the h future values using the selected cluster-based model.

8. The method as claimed in claim 1, further comprising:
performing (S1518) the method (1500) periodically whenever the time-series collects a fixed number of new points; and
storing (S1520) the cluster-specific refined models in the repository.

9. The method as claimed in claim 1 wherein mapping (S1510) each sample of the time-series to the cluster corresponding to the time-frequency image of the time-series segment that the sample belongs to, further comprises the steps of:
identifying different contiguous stretches of the time-series within the time-series samples mapped to the same cluster;
dividing each stretch into non-overlapping window-size segments; and
discarding the last segment of the stretch and collecting the remaining segments from each stretch.

10. A system (1600) for forecasting in a non-stationary time-series, the system comprising:
a generating unit (1602) for generating a plurality of time-frequency images for a plurality of overlapping time-series segments of a user-specified window size, wherein the time-frequency images are generated by employing a continuous wavelet and obtaining the continuous wavelet transform at different scales;
an applying unit (1604) for applying a pre-trained deep convolutional neural network trained on a plurality of images to the time-frequency images to output a high dimensional numerical vector for each time-frequency image;
an obtaining unit (1606) for obtaining 2D representation for each output numerical vector by applying any dimensionality reduction technique on the collection of numerical vectors;
a partitioning unit (1608) for automatically partitioning the 2D representations into clusters by applying a clustering algorithm and an objective criterion such as Bayesian Information Criterion (BIC) to select the optimal number of clusters;
a mapping unit (1610) for mapping each sample of the time-series to the cluster corresponding to the time-frequency image of the time-series segment that the sample belongs to, for collecting time-series segments from stretches identified within the time-series samples;
an assembling unit (1612) for assembling a cluster-specific Auto-Regressive Moving Average (ARMA) forecast model considering all the non-overlapping segments of the time-series that belong to the cluster; and
a maintaining unit (1614) for maintaining all cluster specific ARMA models in a repository.

11. The system as claimed in claim 10, wherein any continuous wavelet is used to generate time-frequency images for each time-series segment; and wherein the default wavelet is set to Morlet wavelet.

12. The system as claimed in claim 10, wherein the pre-trained deep convolutional neural network is applied to each time-frequency image to output a high dimensional numerical vector; and wherein the neural network is set to ResNet50.

13. The system as claimed in claim 10, wherein the obtaining unit (1606) for obtaining 2D representation for each output numerical vector by applying any dimensionality reduction technique such as the Uniform Manifold Approximation and Projection (UMAP) on the collection of numerical vectors.

14. The system as claimed in claim 10, wherein the partitioning unit (1608) for automatically partitioning the 2D representation points into clusters further comprises:
an applying unit (16081) for applying the BIC over a plurality of different clusters; and
a selecting unit (16082) for selecting a plurality of clusters that correspond to the maximal BIC.

15. The system as claimed in claim 10, wherein the assembling unit (1612) for assembling a cluster-specific forecast model further comprises:
a removing unit (16122) for removing trend from each time-series segment of the collecting unit (1610a) to convert each window-size segment of the time-series into a stationary time-series segment; and
an applying unit (16123) for applying an ARMA model over the collection of stationarized partitions of the cluster, wherein the model is identified by selecting the number of autoregressive terms, p, and the number of moving average terms, q according to the Akaike Information Criterion (AIC).

16. The system as claimed in claim 10, further comprises:
a performing unit (1616) for performing forecasts on the time-series at any time t for a future horizon, h, at every new instant

17. The system as claimed in claim 15, wherein the performing unit (1616) for performing forecasts on the time-series at any time t for a future horizon, h further comprises:
a window length segment unit (16161) for considering a window length segment of the time-series backwards from t;
a generating unit (16162) for generating the time-frequency image corresponding to the window length segment of the time-series by applying the continuous wavelet transform using the user-selected wavelet;
a passing unit (16163) for passing the generated time-frequency image through the deep convolutional neural network to extract a numerical vector from the said time-frequency image;
an identification unit (16164) for identifying the matching cluster for the time-frequency image by applying the UMAP;
a selecting unit (16165) for selecting the corresponding cluster specific model in the repository using the index of the identified cluster; and
a forecasting unit (16166) for forecasting the h future values using the selected cluster-based model.

18. The system as claimed in claim 10, further comprising
a performing unit (1618) to periodically evaluate the forecasting model whenever the time-series collects a fixed number of new samples; and
a storing unit (1620) for storing the cluster-specific refined models in the repository.

19. The system as claimed in claim 10, wherein the mapping unit (1610) further comprises:
a collecting unit (16101) for identifying different contiguous stretches of the time-series within the time-series samples mapped to a cluster;
a dividing unit (16102) for dividing each stretch into contiguous non-overlapping window size segments; and
a discarding unit (16103) for discarding the last segment of the stretch and collecting the remaining segments from each stretch.
